(19) United States
(12) Patent Application Publication
(10) Pub. No.: US 2009/0089740 A1
(43) Pub. Date: Apr. 2, 2009

(54) System For Generating Linked Object Duplicates

(76) Inventor: Wynne Crisman, Colorado Springs, CO (US)

Correspondence Address: DECLARATIVE ENGINEERING, LLC, 232 CUSTAR AVE., COLORADO SPRINGS, CO, 80903, US

(21) Appl. No.: 11/844,640

(22) Filed: Aug. 24, 2007

(51) Int. Cl. G06F 9/44

(52) U.S. Cl. 717/106

(57) ABSTRACT

A method of creating, managing, and synchronizing full or partial object copies in a distributed object oriented software system. Copies of an object or another object copy can be made using the same class definition. The copies are kept up to date by the copied object and changes are synchronized on demand back to the copied object. Partial copies retrieve additional object data as requested or needed.

### CROSS REFERENCE TO RELATED APPLICATIONS

N/A

### STATEMENT REGARDING FEDERALLY SPONSORED RESEARCH OR DEVELOPMENT

N/A

### BACKGROUND OF THE INVENTION

The present invention is generally related to the duplicating of data in an object oriented software system, and more particularly to how data objects are copied within a process, or between processes, how the copies are updated to reflect the latest state in the copied object, and how the copy can synchronize its changes back to the copied object.

Providing access to data within a system, whether the data is local or remote, is significantly complicated when multiple threads or users require access to the same data set at the same time. Most modern software systems avoid the issue by loading the data from the data store once for each user of the data. Changes to the data are then ‘shared’ by saving back to the data store such that future users will load the new data. One major issue with this solution is if two users modify the same data at the same time and store the data, then the last user's changes overwrite the first user's changes without any notification. This solution does not actually allow users to share the same data, but rather each user has a copy that is static, meaning it does not get updated when another user makes and saves a change.

Another method commonly used to share data is to lock the data object when accessing or altering the data. This can cause serious threading and performance problems. Often a set of changes requires multiple locks which commonly lead to deadlock situations where two or more threads wait indefinitely for a subset of the required locks while holding the rest of the required locks. Performance problems occur when one thread is holding locks another thread requires, causing the thread to block until the locks become available.

Often distributed systems share objects by creating proxies to the data object. The proxy is a thin interface to a local or remote object responsible for transmitting requests and responses to and from the actual data object on another process. Proxies do allow multiple users on remote systems to view the same data, but does not allow shared modification of data between users.

### BRIEF SUMMARY OF THE INVENTION

In accordance with the present invention, data objects are defined such that they inherit or define duplication methods allowing for full or partial duplicates to be created and managed. Upon a user request, the data object is duplicated, ensuring that the user receives the requested parts of the data object. The duplicate, is referenced by the original duplicated object so that updates to the duplicated object can be forwarded to the duplications. The duplicate uses the same source code as the duplicated object and the user of the duplicate need not know that it is not the original object. Changes made to the duplicate object are tracked, and the duplicate sends the changes to the duplicated object when saved. Saving locks the duplicated object, updates it, and then notifies the other duplicates of the modified object. Duplicates can also be made of other duplicates, creating a duplication tree. Proxies, or thin interfaces to objects another process, to the duplicated object can also be used to create duplicates, allowing the duplicate objects to be remote from the duplicated object. Duplicate objects need not have the full state for the object, and can load missing state when requested, including automatically duplicating referenced objects and collections of objects.

The present invention provides a way to have multiple users accessing the same data set at the same time, all with modification privileges, and even across process boundaries. This allows one user's saved changes to be immediately visible to all other users, and it provides each user with space to make changes without affecting other users (prior to saving). Locking is handled by the system and only allows one lock at a time per thread, removing the possibility of deadlocks. Changes to the reflected data object are managed such that one user's changes cannot overwrite another user's without the user being aware of the fact.

### BRIEF DESCRIPTION OF THE DRAWING

Other features and advantages of the present invention will become apparent in light of the following detailed description of the drawing, in conjunction with the drawing, of which:

FIG. 1 is a class diagram demonstrating a class implementing the duplication code.

FIG. 2 depicts the interaction between duplicate objects and duplicated objects.

FIG. 3 demonstrates object relationships as they are duplicated within a process.

FIG. 4 demonstrates object relationships as they are duplicated over a network.

FIG. 5 is a sequence diagram laying out the process for duplicate object creation.

FIG. 6 is a sequence diagram detailing the process of updating and synchronizing a duplicate object.

FIG. 7 is a sequence diagram detailing the process of releasing a duplicate object.

### DETAILED DESCRIPTION OF THE INVENTION

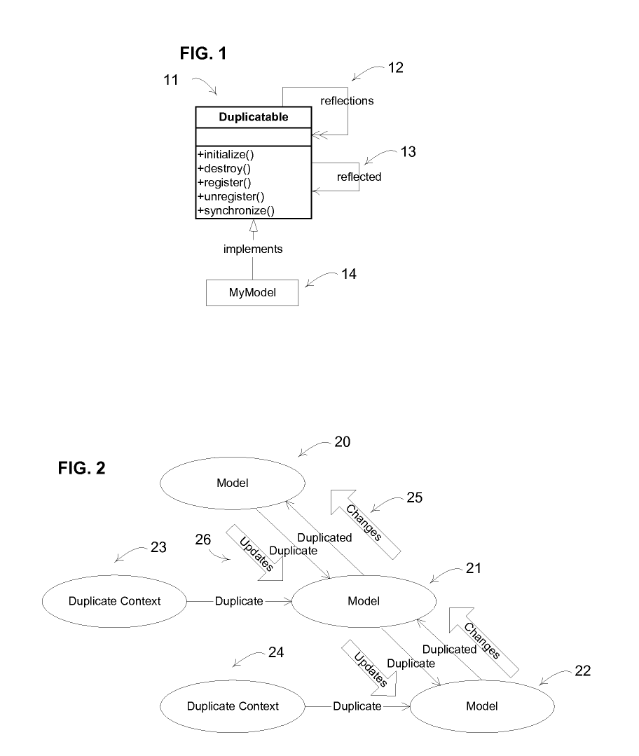

Referring to FIG. 1, model classes 14 implement or extend a duplicatable interface 11 which defines method required by a duplicatable model. The interface also ensures there are bi-directional references 12, 13 between the duplicated and the duplicate instances so that updates may be sent from a duplicated instance to all duplicates, and changes may be synchronized from a duplicate to the duplicated instance. This architecture allows for the duplicate object to use the same class source as the duplicated object.

Duplicates of models may be created within a single process from a non duplicate model, or from a duplicate model as shown in FIG. 2. This object interaction diagram shows that a duplicate context object 23 is used to create and maintain a model object 21 which is a duplicate of a model object 20. The arrows 25, 26 show that changes flow from the duplicate object to the duplicated object and updates to the duplicated object flow back to the duplicate objects. This diagram also shows that a duplicate object 22 can be created from a duplicate object 21 using a different duplicate context instance 24, allowing a tree of duplicate objects to be created.

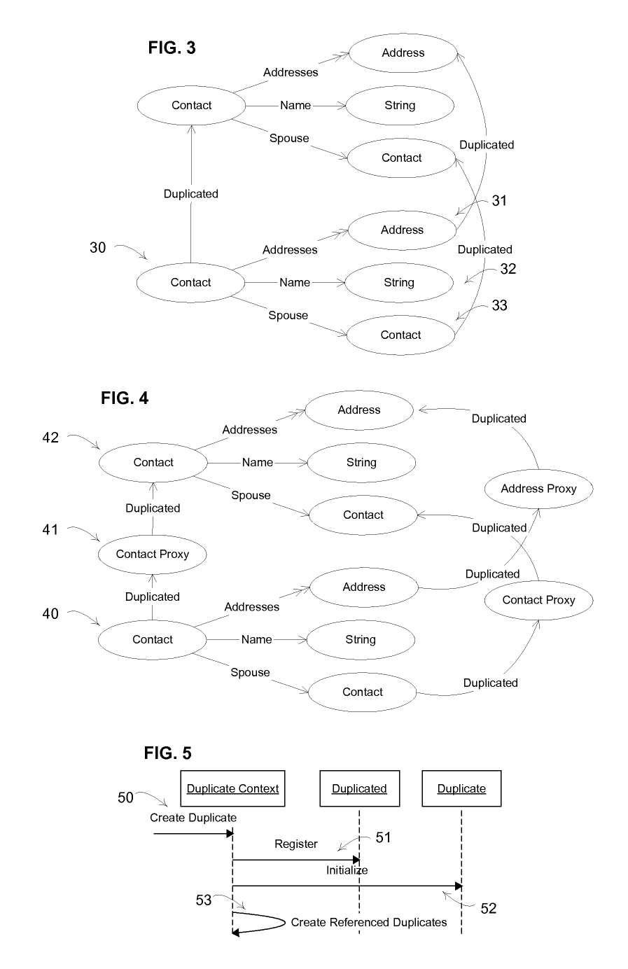

In FIG. 3, we are demonstrating a more complex and concrete object interaction diagram for a contact object which contains addresses and a name, and references a spouse contact. The contact duplicate 30 references a duplicate of a collection of address duplicates 31, a duplicate of the referenced spouse contact 32, and it references a copy of the name 33 since strings do not implement the Duplicatable interface and therefor are assumed to be immutable. FIG. 4 builds on this same scenario by showing how a duplicate of the contact and related objects can be created across process boundaries using proxies to the duplicated objects. Here the contact duplicate 40 references a proxy 41 of the duplicated contact 42 which may exist on a remote process.

FIG. 5 shows the sequence of events that create a duplicate object. The user code first makes a call 50 to its duplicate context to create a duplicate instance, passing either a local reference or proxy to an object or collection that can be duplicated. The context first makes a call 51 to the duplicated object to register a new reflection. The register method FIG. 1, 11 is called resulting in a serializable package of duplication data used to setup the duplicate object. The context then creates a new instance of the same type as the duplicated object and then calls the initialize method FIG. 1, 11 passing the package of duplication data. The duplicate object then unpacks the duplication data, sets up the duplicate, and notifies the context of any additional duplicates that must be created to complete the process. The context then creates any additional duplicates 53 by repeating this process from 51 for each addition duplicate required.

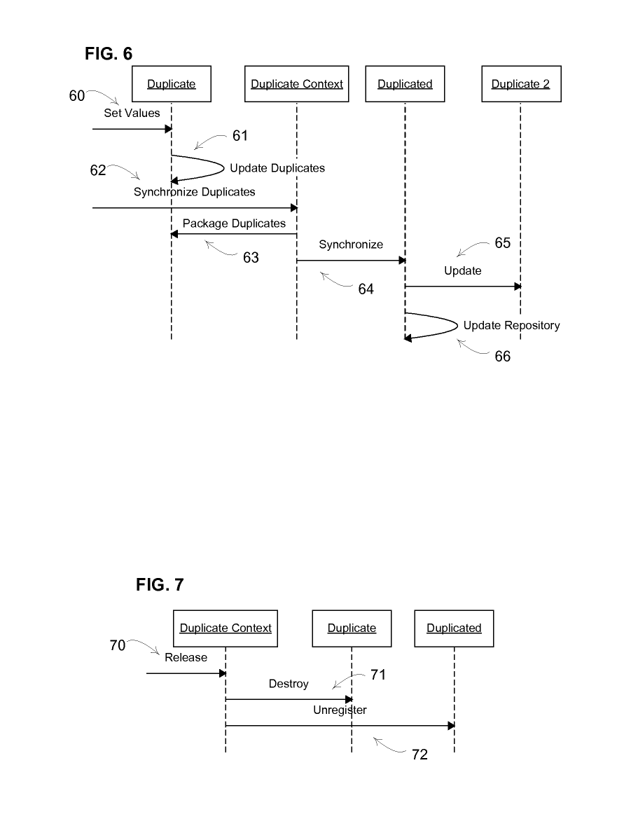

Duplicate objects can be altered without affecting the duplicated object or other duplicate objects of the duplicated object until the user code synchronizes the changes as depicted in FIG. 6. The user can make any changes desired to the duplicate object 60 which will send updates 61 to any duplicates of the duplicate object. When the changes are complete, the user code can request that the duplicate context synchronize 62 the changes to the duplicate object or to any set of duplicate objects created by the context. The duplicate context identifies the altered duplicates within the requested set and requests 63 that they package those changes for delivery to the duplicated objects. The packages of changes are then delivered to the duplicated objects via a call 64 to their synchronize FIG. 1, 11 method. One at a time, each logical (an individual or tree of part-of objects where one object may be part-of another object and thus share a lock) duplicated object is locked, applies the changes, then sends updates 65 to any other duplicates other than the one requesting the changes. Finally, if the duplicated object is not its self a reflection, it will be given an opportunity 66 to update optional repositories within the context of the lock.

When the user code is done with its duplicate objects as in FIG. 7, it will release the duplicate context 70. The duplicate context will call 71 destroy FIG. 1, 11 on each duplicate created by the context to mark the duplicate as no longer being active. The context will then notify each duplicated object that the duplicate is no longer active with a call 72 to unregister FIG. 1, 11. The duplicated object will remove the meta-data for the duplicate and will stop sending updates.

What is claimed is:

1) A method for creating a whole or partial duplicate of an existing object or proxy to an existing and potentially remote object using the same class source code, comprising the steps of:
referencing an existing object implementing the duplicatable interface
creating a duplicate context
passing the duplicatable object or a proxy for the duplicatable object to the duplicate context in order to create the duplicate object

2) The method of claim 1 further including the step of modifying the duplicated object's data which updates the duplicate objects for the modified duplicated object.

3) The method of claim 1 further including the step of modifying the duplicate object's data which update any duplicates of the duplicate object, but does not automatically update the duplicated object.

4) The method of claim 3 further including the step of requesting the duplicate object synchronize its changes, sending all modifications to be applied to the duplicated object, subsequently updating all duplications for the duplicated object and providing an opportunity to update related repositories if the duplicated object is not its self a duplicate.

5) The method of claim 1 further including the step of destroying the duplicate object and unregistering the duplicate object with the duplicated object.

6) A computer program fixed on a computer-readable medium and adapted to operate on a computer to provide object duplication in an object oriented software application, comprising:
a single class source code implementing the duplicatable interface and defining the original object and the duplicate objects at runtime
a duplication context which creates, destroys, synchronizes, and updates a set of duplicates
